(19) United States
(12) Patent Application Publication
(10) Pub. No.: US 2022/0403599 A1
(43) Pub. Date: Dec. 22, 2022

(54) UNCOATED NONWOVEN FIBER MAT

(71) Applicant: Owens Corning Intellectual Capital, LLC, Toledo, OH (US)

(72) Inventors: Xin Wang, Charlotte, NC (US); Jianhui Wu, Westerville, OH (US); Aaron Mann, Columbus, OH (US)

(21) Appl. No.: 17/762,139

(22) PCT Filed: Sep. 22, 2020
(86) PCT No.: PCT/US20/51922

§ 371 Date: Mar. 21, 2022

Related U.S. Application Data
(60) Provisional application No. 62/906,859, filed on Sep. 27, 2019.

(51) Int. Cl. D21H 19/12; B32B 5/02; B32B 5/08; B32B 13/14; D04H 1/4382; D04H 1/587; D04H 1/4218; D04H 1/4209; D04H 1/732; D21H 13/40; C04B 28/14

(52) U.S. Cl. CPC D21H 19/12; B32B 5/022; B32B 5/08; B32B 13/14; D04H 1/43835; D04H 1/587; D04H 1/4218; D04H 1/43838; D04H 1/4209; D04H 1/732; D21H 13/40; C04B 28/14; B32B 2260/021; B32B 2260/046; B32B 2262/02; B32B 2262/101; B32B 2262/106; B32B 2262/105; B32B 2262/144; B32B 2307/7265; B32B 2307/718; B28B 19/0092

(57) ABSTRACT

An uncoated nonwoven fibrous mat having a reduced air porosity is disclosed comprising a first plurality of fibers having a length between about 10 mm and 20 mm and an average diameter between about 9 μm and 15 μm; a second plurality of fibers having a length between about 3 mm and 8 mm and an average diameter between about 5 μm and 8 μm; and a binder composition. The uncoated nonwoven fibrous mat has an air porosity less than about 550 CFM.

### CROSS-REFERENCE TO RELATED APPLICATIONS

This application claims priority to and the benefit of U.S. Provisional Application No. 62/906,859, filed Sep. 27, 2019, the entire content of which is incorporated by reference herein.

### FIELD

The general inventive concepts relate to nonwoven mats, and also to uncoated nonwoven, fiberglass mats with reduced air porosity and gypsum bleed-through.

### BACKGROUND

Conventional glass fibers are useful in a variety of applications including reinforcements, building materials, textiles, and acoustical and thermal insulation materials. Nonwoven mats may be made from the fibers by conventional wet-laid processes, wherein wet chopped fibers are dispersed in a water slurry that contains surfactants, viscosity modifiers, defoaming agents, and/or other chemical agents. The slurry containing the fibers is delivered onto a moving screen where a substantial portion of the water is removed, leaving behind a web comprising the fibers and the various chemical agents in the slurry adhered to the fibers. A binder is then applied to the web, and the resulting mat is dried to remove any remaining water and cure the binder. The formed nonwoven mat is an assembly of dispersed, individual chopped fibers.

The binder composition works as an adhesive to bind the fibers together to form a cohesive product, while also improving the product's properties, such as form recovery, stiffness, acoustical openness, porosity, and structure.

Wall boards, such as gypsum or foam composite board panels, are used in building construction to form the partitions or walls of rooms, hallways, ceilings, and the like. Similar boards are also used in exterior wall or roof construction, such as sheathing or roof deck. Such composite boards may include facing or back mats, such as fiberglass or other woven or nonwoven mats, on one or both faces to enhance the performance properties of the board, such as board strength, rigidity, weather durability, and moisture or mold resistance. Such woven or nonwoven mats may be manufactured in-line with the wall board or independently thereof.

One issue facing such mat-faced boards, such as fiberglass-faced gypsum boards, is due to the high porosity of fiber nonwoven mats, which often leads to bleed through of gypsum or other core materials. Various solutions have been attempted to combat gypsum bleed through, such as the use of microfibers (i.e., fibers having a diameter of 6 microns or less) in the nonwoven mat and/or the application of a coating composition to one or more surfaces of the nonwoven mat. However, the use of microfibers introduces challenges, such as dispersion and processing issues. For instance, microfibers are generally more difficult to disperse in white water, causing fiber bundles to form, leading to defects in downstream nonwoven mats. Also, due to the small size of the fibers, the fibers may not be caught by the wire mesh above the vacuum slot on a processing line. Thus, the fibers may be vacuumed during non-woven mat production, causing the fibers to contaminate a white-water or binder system, which causes processing issues.

Conventional coating compositions include various formulations that typically include mineral pigments and an organic binder. However, although such coating compositions are useful in preventing bleed through, application of such compositions requires additional processing equipment, time, and expense.

Accordingly, it would be desirable to provide more cost and time effective solutions to reducing the porosity and bleed through in nonwoven mats and mat-faced panels.

### SUMMARY

Numerous other aspects, advantages, and/or features of the general inventive concepts will become more readily apparent from the following detailed description of exemplary embodiments and from the accompanying drawings being submitted herewith.

Various exemplary aspects of the present inventive concepts are directed to an uncoated nonwoven fibrous mat that includes a first plurality of fibers having a length between about 10 mm and 20 mm and an average diameter between about 9 μm and 15 μm; a second plurality of fibers having a length between about 3 mm and 8 mm and an average diameter between about 5 μm and 8 μm; and a binder composition selected from the group consisting of acrylic binders, formaldehyde binders, and mixtures thereof, the binder composition including one or more water-repellent additives. The uncoated nonwoven fibrous mat has an air porosity less than about 550 CFM.

The first and second plurality of fibers may comprise one or more of glass fibers, carbon fibers, mineral fibers, ceramic fibers, natural fibers, and synthetic fibers. In at least some exemplary embodiments, a least one of the first and second plurality of fibers comprise glass fibers.

In some exemplary embodiments, the first plurality of fibers has an average diameter of about 10 microns to about 13 microns and the second plurality of fibers has an average diameter of about 6 microns to about 7.5 microns. The first plurality of fibers and second plurality of fibers may be present in the nonwoven fibrous mat in a ratio from about 1:1 to about 5:1.

As mentioned above, the uncoated nonwoven fibrous mat may be formed using a binder composition that includes water-repellent additives such as, for example, silicone-based hydrophobing agents, wax additives, fluorocarbon compounds, or mixtures thereof.

The uncoated nonwoven fibrous mat formed in accordance with the present inventive concepts may have a Cobb value less than 1.0 g, such as less than about 0.5 g, or less than about 0.1 g.

Further exemplary aspects of the present inventive concepts are directed to a gypsum board comprising a gypsum core having a first surface and an opposing second surface; and at least one uncoated nonwoven fibrous having a first side and a second side, opposite the first side, wherein the first side of the uncoated nonwoven fibrous mat is adhered to the first surface of the gypsum core. The uncoated nonwoven mat comprises a first plurality of fibers having a length between about 10 mm and 20 mm and an average diameter between about 9 μm and 15 μm; a second plurality of fibers having a length between about 3 mm and 8 mm and an average diameter between about 5 μm and 8 μm; and a binder composition selected from the group consisting of acrylic binders, formaldehyde binders, and mixtures thereof. The binder composition includes one or more water-repellent additives. The water-repellent additives may comprise fluorocarbons, fluorine-containing polymers or oligomers, fluorine-containing polysiloxane, or mixtures thereof.

In some exemplary embodiments, the core penetrates less than 5% of the second side of the uncoated nonwoven fibrous mat, under a pressure of 4.3 kg.

The first and second plurality of fibers may comprise one or more of glass fibers, carbon fibers, mineral fibers, ceramic fibers, natural fibers, and synthetic fibers. In some exemplary embodiments, at least one of the first and second plurality of fibers comprises glass fibers.

The gypsum board of claim 13, wherein the first and second plurality of fibers are present in the nonwoven fibrous mat in a ratio from about 1:1 to about 5:1.

In some exemplary embodiments, the gypsum core penetrates less than 2.5% of the second side of the uncoated nonwoven fibrous mat, under a pressure of 4.3 kg.

Yet further exemplary aspects of the present inventive concepts are directed to a method for manufacturing an uncoated nonwoven mat with reduced air porosity. The method includes mixing a first plurality of fibers having a length between about 10 mm and 20 mm and an average diameter between about 9 μm and 15 μm and a second plurality of fibers having a length between about 3 mm and 8 mm and an average diameter between about 5 μm and 8 μm with a white-water solution to disperse the fibers and form a blended glass fiber slurry; depositing the blended glass fiber slurry on a conveying apparatus; removing a portion of the water from the slurry to form a fiber web; and applying a binder composition to the fiber web, forming a binder-coated fiber web; and curing the binder-coated fiber web, forming an uncoated nonwoven mat. The uncoated nonwoven mat has an air porosity less than about 550 CFM.

### BRIEF DESCRIPTION OF THE DRAWINGS

The general inventive concepts, as well as embodiments and advantages thereof, are described below in greater detail, by way of example, with reference to the drawings in which:

FIG. 1 graphically illustrates the air porosity for exemplary uncoated nonwoven fibrous mats.

FIG. 2 graphically illustrates the air porosity for exemplary uncoated nonwoven fibrous mats.

FIG. 3 illustrates the gypsum bleed-through for conventional uncoated nonwoven mats, as compared to uncoated nonwoven mats made in accordance with the present inventive concepts.

FIG. 4 graphically illustrates the air porosity for exemplary uncoated nonwoven fibrous mats.

FIG. 5 graphically illustrates the Cobb value for exemplary uncoated nonwoven fibrous mats.

FIG. 6 illustrates the reduction of gypsum bleed-through demonstrated in uncoated nonwoven mats made in accordance with the present inventive concepts.

### DETAILED DESCRIPTION

Unless otherwise defined, all technical and scientific terms used herein have the same meaning as commonly understood by one of ordinary skill in the art to which this application pertains. Although other methods and materials similar or equivalent to those described herein may be used in the practice or testing of the exemplary embodiments, exemplary suitable methods and materials are described below. In case of conflict, the present specification including definitions will control. In addition, the materials, methods, and examples are illustrative only and not intended to be limiting of the general inventive concepts.

The terminology as set forth herein is for description of the exemplary embodiments only and should not be construed as limiting the application as a whole. Unless otherwise specified, “a,” “an,” “the,” and “at least one” are used interchangeably. Furthermore, as used in the description of the application and the appended claims, the singular forms “a,” “an,” and “the” are inclusive of their plural forms, unless contradicted by the context surrounding such.

Unless otherwise indicated, all numbers expressing quantities used in the specification and claims are to be understood as being modified in all instances by the term “about.” The term “about” means within +/−10% of a value, or in some instances, within +/−5% of a value, and in some instances within +/−1% of a value.

By “substantially free” it is meant that a composition includes less than 1.0 wt. % of the recited component, including no greater than 0.8 wt. %, no greater than 0.6 wt. %, no greater than 0.4 wt. %, no greater than 0.2 wt. %, no greater than 0.1 wt. %, and no greater than 0.05 wt. %. In any of the exemplary embodiments, “substantially free” means that a composition includes no greater than 0.01 wt. % of the recited component.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” Thus, use of the term “or” herein is the inclusive, and not the exclusive use.

The terms “binder,” “binder composition,” and “curable composition,” as used herein, are used interchangeably and refer to a material that holds one or more components of a nonwoven article together. Those of ordinary skill in the art will understand that a binder composition is often an aqueous mixture or solution of dissolved ingredients that cures to interconnect fibers together.

The terms “binder solids” or “binder components,” as used herein, are used interchangeably and refer to the functional ingredients of the binder composition prior to addition or mixing with water to form the ultimate binder for application to the inorganic fibers.

The terms “nonwoven,” “mat,” “veil,” and “facer” are used interchangeably herein and refer to a bound web of fibers.

Ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the nonwoven mat and vice versa.

The general inventive concepts relate to an uncoated nonwoven mat formed with reduced air porosity and bleed through potential. The nonwoven mat comprises nonwoven web of reinforcement fibers, such as inorganic fibers.

Suitable fibers for use in the nonwoven mat include, but are not limited to, glass fibers, carbon fibers, mineral fibers such as mineral wool and rock wool, ceramic fibers, natural fibers, and/or synthetic fibers. The glass fibers can be made from any type of glass. Examples of glass fibers include A-type glass fibers, C-type glass fibers, E-type glass fibers, H-type glass fibers, S-type glass fibers, ECR-type glass fibers (e.g., Advantex® glass fibers commercially available from Owens Corning), Hiper-tex™ glass fibers, high performance glass fibers, wool glass fibers, and combinations thereof. Natural fibers are plant fibers extracted from any part of a plant, including, but not limited to, the stem, seeds, leaves, roots, or phloem. Examples of natural fibers which may be suitable for use as the reinforcing fiber material include basalt, cotton, jute, bamboo, ramie, bagasse, hemp, coir, linen, kenaf, sisal, flax, henequen, and combinations thereof. Synthetic fibers are man-made fiber having suitable reinforcing characteristics, such as polyester, polyethylene, polyethylene terephthalate, polypropylene, polyamide, aramid, and polyaramid fibers, as well as combinations thereof.

Glass fibers may be formed by conventional methods known to those skilled in the art. For example, the glass fibers may be formed by a continuous manufacturing process in which molten glass passes through the holes of a “bushing,” the streams of molten glass thereby formed are solidified into filaments, and the filaments are combined together to form a fiber, “roving,” “strand,” or the like.

After the glass fibers are drawn from the bushing, an aqueous sizing composition (also referred to as a size) may optionally be applied to the fibers. The sizing composition is not limited, and may be any sizing known to those of skill in the art. Generally sizing compositions contain a lubricant to protect the fibers from damage by abrasion. The sizing composition may be applied by conventional methods such as by an application roller or by spraying the size directly onto the fibers. The size protects the glass fibers from breakage during subsequent processing, helps to retard interfilament abrasion, ensures the integrity of the strands of glass fibers, promotes the interconnection of the glass filaments that form the strand, etc. After the glass fibers are treated with the sizing composition, they may be chopped for subsequent processing into a fibrous non-woven mat.

Fibrous non-woven mats generally comprise randomly matted fibers bonded together by a cured thermoset or dried thermoplastic polymeric binder. The processes for forming such mats are generally well known, including for example, the well-known wet-laid processing and dry-laid processing methods. During the wet-laid process, chopped glass fibers are provided to a conveying apparatus, such as a conveyor, by a storage container for conveyance to a mixing tank that may contain a white-water solution (e.g., various surfactants, viscosity modifiers, defoaming agents, and/or other chemical agents) with agitation to disperse the fibers and form a chopped glass fiber slurry. The glass fiber slurry may then be transferred to a head box where the slurry is deposited onto a conveying apparatus, such as a moving screen or conveyor, and a substantial portion of the water from the slurry is removed to form a web (mat) of enmeshed fibers. The water may be removed from the web by a conventional vacuum or air suction system.

A binder composition is then applied to the web by a suitable binder applicator, such as, for example, a spray applicator, curtain coater, or other means. Once the binder composition has been applied to the mat, the binder coated mat may be passed through at least one drying oven to remove any remaining water and cure the binder composition. The formed nonwoven fiber mat that emerges from the oven is an assembly of randomly oriented, dispersed, individual glass fibers. The fiber mat may be rolled onto a take-up roll for storage or later use.

A dry-laid process is a process in which fibers are chopped and air blown onto a conveyor, after which a binder is then applied and cured to form the mat.

Fiber-reinforced nonwoven mats may be are used in a variety of applications. For example, nonwoven fiberglass mats are used as reinforcement in ceiling tiles, building materials, roofing shingles, and wall panels, among other applications. One challenge of using fiberglass nonwoven mats in such applications is the inherent relative openness of conventional fiberglass mats, especially when used as a facer or back mat in the manufacture of construction boards (i.e., wallboard, insulation board, and other composite boards and panels) comprised of, for example, gypsum or polyisocyanurate (polyiso).

Gypsum wallboard and gypsum panels are traditionally manufactured by a continuous process. A gypsum slurry is first generated in a mechanical mixer (sometimes called a pin mixer) by mixing at least one of anhydrous calcium sulfate (CaSO₄) and calcium sulfate hemihydrate (CaSO₄.1/2 H₂O, also known as calcined gypsum), water, and other substances, which may include set accelerants, waterproofing agents, mineral, glass, or other synthetic reinforcing fibers, and the like. The gypsum slurry is normally deposited on a continuously advancing, lower facing sheet, such as kraft paper or a non-woven fibrous mat. Various additives, e.g. cellulose and glass fibers, are often added to the slurry to strengthen the gypsum core once it is dry or set. A continuously advancing upper facing sheet is laid over the gypsum. The facing sheets and gypsum slurry are passed between parallel upper and lower forming plates or rolls in order to generate an integrated and continuous strip of unset gypsum sandwiched between the sheets. The core begins to hydrate back to gypsum (CaSO₄.2H₂O) by a process known as “setting,” since the rehydrated gypsum is relatively hard. The set core is generally termed a gypsum core, notwithstanding the presence of other constituents and reinforcements. Preferably, the set core comprises at least 85% by weight of hydrated gypsum.

The gypsum boards may then be fed into drying ovens or kilns to evaporate excess water. Once the dried gypsum boards are removed from the ovens, the ends of the boards are trimmed off and the boards are cut to desired sizes. The boards are commonly sold to the building industry in the form of sheets nominally 4 feet wide and 8 to 12 feet or more long and in thicknesses from nominally about ¼ to 1 inches, the width and length dimensions defining the two large faces of the board.

The ability of the inventive nonwoven mats to achieve lower air porosity with a reduced occurrence of gypsum bleed through without the need to apply a coating composition has great cost and manufacturing advantages. A highly permeable facer would lead to bleed through of underlying material, such as gypsum in a wallboard converting process; whereas a very low permeability would lead to moisture being trapped in the downstream converting process of a gypsum board. The present nonwoven mat permits one to control the mat porosity by adjusting the fiber size and blend ratio, along with optionally selecting particular additives to include in the binder composition.

Thus, in any of the exemplary embodiments, the subject nonwoven mats comprise a novel blend of fiber diameters and lengths that target reducing air porosity and bleed through. In general, the fibers have an average diameter of less than 20 microns, including average diameters of 0.1 microns to 20 microns. The fibers further have an average length in the range of 1 mm to 40 mm, including a length of 5 mm to 30 mm, or 10 mm to 25 mm, or 15 mm to 20 mm.

In any of the exemplary embodiments, the nonwoven mat comprises a novel blend of at least two groups of fibers having different average diameters. For instance, the nonwoven mat may comprise a first group of fibers having an average diameter between 9 μm and 15 μm, including between 10 μm and 13 μm. The first group of fibers may comprise a length between about 10 mm and 25 mm, including between about 15 mm and 20 mm, and between about 17 mm and 19.5 mm. The nonwoven mat may comprise a second group of fibers having an average diameter less than 10 μm, such as less than 9 μm, or less than 8 μm. In some exemplary embodiments, the second group of fibers have an average diameter in the range of about 5 μm to about 8 μm, including a range of about 6 μm to about 7.8 μm, or about 6.5 μm to about 7.5 μm. The second group of fibers may have a length of less than 20 mm, such as less than 15 mm, less than 12 mm, less than 10 mm, or less than 8 mm. In some exemplary embodiments, the second group of fibers has a length between about 3 mm and 8 mm, including between 5 mm and 7 mm.

In any of the exemplary embodiments, the nonwoven mat comprises a novel blend of a first group of fibers, wherein the first group of fibers have an average diameter of 10 μm, 11 μm, or 13 μm and a second group of fibers, wherein the second group of fibers has an average diameter of 6.5 μm or 7.5 μm.

The first group of fibers (larger diameter) and second group of fibers (smaller diameter) may be included in a ratio from about 1:1 to about 5:1, including between about 2:1 to about 4:1. In any of the exemplary embodiments, the first group of fibers comprises about 50 to about 90 weight percent of the total weight of fibers included in the nonwoven mat, including about 55 to about 85 weight percent, or about 50 to about 80 weight percent. The second group of fibers may comprise about 10 to about 50 weight percent of the total weight of fibers included in the nonwoven mat, including about 15 to about 45 weight percent, and about 20 to about 40 weight percent.

In any of the exemplary embodiments, in addition to novel blends of fibers, the subject nonwoven mats with reduced air porosity and bleed through may be formed using a binder composition comprising one or more water-repellent additives.

In any of the exemplary embodiments, the binder is selected from acrylic binders, urea-formaldehyde binders (UF), acrylic/urea formaldehyde binders, polyvinyl alcohol, polyvinylacetate, and carbohydrate-based binders, among others. In certain exemplary embodiments, the binder is a combined acrylic/urea formaldehyde binder system. In any of the exemplary embodiments, the binder composition comprises 0 to about 25 weight percent acrylic and about 75 to about 100 weight percent urea formaldehyde. In any of the exemplary embodiments, the binder composition comprises about 1 to about 15 weight percent acrylic and about 85 to about 99 weight percent urea formaldehyde.

As mentioned above, the binder composition may include one or more water-repellent additives, which convert the hydrophilic nonwoven mat to hydrophobic. As gypsum slurry is water-born, the water-repellent additives further help reduce gypsum bleed-through. The water repellent additives may comprise hydrophobing agents, such as silicone-based hydrophobing agents, wax additives, and flurocarbon compounds. Examples of silicone-based hydrophobing agent include TEGO® Phobe 1401 and TEGO® Phobe from Evonik. Examples of wax additives include Aquacer 497 and Aquacer 539 from BYK. Examples of fluorocarbon compounds include Nuva N2114, Nuva N2155 and Nuva 2116 from Archroma. There are also environmentally-friendly options for water repellent additives such as NEOSEED NR-158, NEOSEED NR-2000 and NK ASSIST FU from NICCA USA, INC.

In any of the exemplary embodiments, the binder composition further includes a corrosion inhibitor to reduce or eliminate any potential corrosion to the process equipment. The corrosion inhibitor can be chosen from a variety of agents, such as, for example, triethanolamine, hexamine, benzotriazole, phenylenediamine, dimethylethanolamine, polyaniline, sodium nitrite, benzotriazole, dimethylethanolamine, polyaniline, sodium nitrite, cinnamaldehyde, condensation products of aldehydes and amines (imines), chromates, nitrites, phosphates, hydrazine, ascorbic acid, tin oxalate, tin chloride, tin sulfate, thiourea, zinc oxide, nitrile, and combinations thereof. In any of the embodiments, the corrosion inhibitor is triethanolamine. The corrosion inhibitor may be present in the binder composition in an amount from about 0% to about 15% by weight, from about 1% to about 10% by weight, from about 2% to about 7% by weight, or about 5% by weight of the total solids in the binder composition.

In any of the exemplary embodiments, the binder composition may optionally contain at least one coupling agent. The coupling agent may be a silane coupling agent. The coupling agent may be present in the binder composition in an amount from about 0.01% to about 5% by weight, from about 0.01% to about 2.5% by weight, from about 0.1% to about 0.5% by weight, or about 0.2% by weight of the total solids in the binder composition.

Non-limiting examples of silane coupling agents that may be used in the binder composition may be characterized by the functional groups alkyl, aryl, amino, epoxy, vinyl, methacryloxy, ureido, isocyanato, and mercapto. In any of the exemplary embodiments, the silane coupling agent includes silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes.

In certain exemplary embodiments, the binder composition may optionally include at least one crosslinking density enhancer to improve the degree of crosslinking of the carbohydrate based polyester binder. Crosslinking density enhancement can be achieved by increasing esterification between the hydroxyl and carboxylic acid groups and/or introducing free radical linkages to improve the strength of the thermoset resin. The esterification crosslinking density can be adjusted by changing the ratio between hydroxyl and carboxylic acid and/or by adding additional esterification functional groups such as triethanolamine, diethanolamine, mono ethanolamine, 1-amino-2-propanol, 1,1′-aminobis,-2-propanol, 1,1′,1″nitrilotri-2-propanol, 2-methylaminoethanol, 2-dimethylaminoethanol, 2-(2-aminoethoxy)ethanol, 2 {(2aminoethyl)amino} ethanol, 2-diethylaminoethanol, 2-butylaminoethanol, 2-dibutylaminoethanol, 2cyclohexylamincethanol, 2,2′-(methylamino)bis-ethanol, 2,2′-(butylamino)bis-ethanol, 1-methylamino-2propanol, 1-dimethylamino-2-propanol, 1-(2-aminoethylamino)-2-propanol, 1,1′-(methylimino)bis-2-propanol, 3-amino-1-propanol, 3-dimethylamino-1-propanol, 2-amino-1-butanol, 1-ethylamino-2-butanol, 4-diethylamino-1-butanol, 1-diethylamino-2-butanol, 3-amino-2,2-dimethyl-1-propanol, 2,2-dimethyl-3-dimethylamino-1-propanol, 4-diethylamino-2-butyn-1-ol, 5-diethylamino-3-pentyne-2-ol, bis (2-hydroxypropyl)amine, as well as other alkanolamines, their mixtures, and their polymers. Another method to achieve crosslinking density enhancement is to use both esterification and free radical reaction for the crosslinking reactions. Chemicals that can be used for both reactions include maleic anhydride, maleic acid, or itaconic acid. The crosslinking density enhancer may be present in the binder composition in an amount from about 0% to about 25% by weight of the total solids in the binder composition.

The binder composition may optionally contain conventional additives such as, but not limited to dyes, pigments, fillers, colorants, UV stabilizers, thermal stabilizers, anti-foaming agents, anti-oxidants, emulsifiers, preservatives (e.g., sodium benzoate), corrosion inhibitors, and mixtures thereof. Other additives may be added to the binder composition for the improvement of process and product performance. Such additives include lubricants, wetting agents, surfactants, antistatic agents, and/or water repellent agents. Additives may be present in the binder composition from trace amounts (such as <about 0.1% by weight the binder composition) up to about 10% by weight of the total solids in the binder composition. In certain exemplary embodiments, the additives are present in an amount from 0.1% to 5% by weight of the total solids in the binder composition.

The binder further includes water to dissolve or disperse the active solids for application onto the reinforcement fibers. Water may be added in an amount sufficient to dilute the aqueous binder composition to a viscosity that is suitable for its application to the reinforcement fibers and to achieve a desired solids content on the fibers. In particular, the binder composition may contain water in an amount from about 50% to about 98% by weight of the total binder composition.

As previously discussed, the general inventive concepts relate to a method of forming a nonwoven mat with reduced air porosity and bleed through. The binder according to the general inventive concepts is generally added during the formation of the nonwoven mat in a wet-laid mat processing line. Chopped fibers are provided to a conveying apparatus such as a conveyor by a storage container for delivery to a mixing tank that contains various surfactants, viscosity modifiers, defoaming agents, and/or other chemical agents with agitation to disperse the fibers and form a glass fiber slurry. The fiber slurry may be deposited onto a conveying apparatus such as a moving screen or foraminous conveyor, and a substantial portion of the water from the slurry is removed to form a wet laid mat of enmeshed fibers. The water may be removed from the web by a conventional vacuum or air suction system. The binder is applied to the mat by a suitable binder applicator, such as a spray applicator, a curtain coater, or other appropriate application means. Once the binder has been applied to the mat, the binder coated mat may be passed through at least one drying oven to remove any remaining water and cure the binder composition. The resulting nonwoven mat that emerges from the oven is an uncoated assembly of substantially randomly oriented, dispersed, individual fibers interconnected by a binder.

The uncoated nonwoven mat formed in accordance with the general inventive concepts herein has a basis weight between about 1.5 lbs/CSF to about 3.5 lbs/CSF, including between about 1.8 lbs/CSF and about 2.7 lbs/CSF, and between about 2.1 lbs/CSF and 2.5 lbs/CSF.

The uncoated nonwoven mat formed in accordance with the general inventive concepts herein has an LOI between about 10% to about 35%, including between about 15% and 28%, and between about 18% and 25%.

The uncoated nonwoven mat demonstrates reduced air porosity, compared to an otherwise identical nonwoven mat that does not include at least one of the novel fiber blend or the hydrophobic binder composition comprising one or more water repellent additives. In some exemplary embodiments, the uncoated nonwoven mat demonstrates an air porosity less than about 600 CFM (rate of flow of air in cubic feet per square foot of sample per minute), such as less than about 575 CFM, less than about 550 CFM, less than about 525 CFM, less than about 500 CFM, and less than about 450 CFM. In some exemplary embodiments, the uncoated nonwoven mats demonstrate an air porosity between about 300 and 550 CFM, such as between about 420 CFM and 535 CFM, and between about 430 CFM and 525 CFM. In some exemplary embodiments, the air porosity of the uncoated nonwoven mat is below 400 CFM, such as below 375 CFM, below 350 CFM, below 425 CFM, below 335 CFM, and below 325 CFM.

The uncoated nonwoven mat demonstrates a Cobb value less than 1 g, which indicates that the mats are hydrophobic. In some exemplary embodiments, the uncoated nonwoven mats demonstrate a Cobb value less than 0.8 g, including less than 0.5 g, less than 0.2 g, less than 0.1 g, less than 0.05 g, less than 0.015 g, or less than 0.01 g.

The general inventive concepts also contemplate the uncoated nonwoven mats discussed herein applied to at least one surface of a core material, as a facer on a construction board. The construction board may have the uncoated nonwoven mat situated on one side of the construction board. In one or more embodiments, an opposing side of the construction board may have a second facer that is the same or different than the uncoated nonwoven mat. In one or more embodiments, the second facer is a paper facer, coated paper facer, foil facer, fiber facer, conventional coated fiber facer, or a second uncoated nonwoven mat, formed in accordance with the present disclosure. In other embodiments, the opposing side of the construction board may not have a facer.

In any of the exemplary embodiments, the uncoated nonwoven mat may be included as a facer on a gypsum board. The gypsum board includes a gypsum core with two opposing sides and at least one uncoated nonwoven mat situated on one of the opposing sides. Wall boards formed of a gypsum core sandwiched between facing layers are commonly used in the construction industry as internal walls and ceilings for both residential and commercial buildings. Formulations and the design of the gypsum board may be tailored for the specific use desired for the board. In one or more embodiments, the gypsum core includes gypsum and optionally wet chopped glass fibers, water resistant chemicals, binders, accelerants, and low-density fillers. In any of the exemplary embodiments, the gypsum board may be prepared by providing a continuous layer of the uncoated nonwoven mat and depositing a gypsum slurry onto one surface of the coated nonwoven mat. A second continuous layer of facing material (either the uncoated nonwoven mat described herein or a different facing material) may then be applied to the opposite surface of the gypsum slurry. In this manner, the gypsum slurry is sandwiched between opposing layers of facing material. The sandwiched gypsum slurry is then adjusted to a desired thickness and dried to harden the gypsum core and form a gypsum board. In other embodiments, the application of the second facer is omitted to prepare a board with a single facer. Next, the gypsum board may be cut to predetermined dimensions (e.g., length) for end use.

In any of the exemplary embodiments, the uncoated nonwoven mats demonstrate less than 5% gypsum bleed-though when a pressure of 4.3 kgs is applied during production of a gypsum board. In any of the exemplary embodiments, the uncoated nonwoven mats demonstrate less than 2.5% gypsum bleed-though when a pressure of 4.3 kgs is applied. In any of the exemplary embodiments, the uncoated nonwoven mats demonstrate zero gypsum bleed-though when a pressure of 4.3 kgs is applied.

In another application, the uncoated nonwoven mat of the present disclosure may be used as a substrate for forming roofing shingles or a roofing underlayment. The reduced porosity of the uncoated nonwoven mat will prevent bleed-through of the asphalt/bitumen.

In some exemplary embodiments, the uncoated nonwoven mat may be included in a polymeric foam board. The foam board includes a foam core with two opposing sides and at least one uncoated nonwoven mat situated on one of the opposing sides. Suitable foams for use in the foam board include polyurethane, polystyrene, and polyisocyanurate foams. Polyisocyanurate and polyurethane foam compositions have three major components: a polyfunctional isocyanate compound, a polyol and a blowing agent. When these three components are mixed, along with small amounts of catalysts and surfactants, a heat-generating chemical reaction causes the liquid blowing agent to boil. The resultant blowing agent vapor expands the foam to create gas-filled cells. A second facer material (either the uncoated facer or a different facing material) may optionally be applied to the opposing surface of the developing foam. The ultimate size of the resultant foam board may be manipulated by adjusting the height of the moving form, i.e., restrained rise, by adjusting the sides of the moving form to a desired width, and by cutting the continuous foam product to a desired length.

In one or more embodiments, the polymeric foam board may be described by the density of the foam material. In these or other embodiments, the foam board has a density or an average density of about 1 lbs./ft³ to about 25 lbs./ft³, and in other embodiments about 2 lbs./ft³ to about 23 lbs/ft³. In other embodiments, the foam board may have a density or an average density less than 2.5 lbs/ft³. In other embodiments, the foam board has a density or an average density of about 1 lbs./ft³ to about 6 lbs./ft³, and in other embodiments about 2 lbs./ft³ to about 5 lbs/ft³.

While particular embodiments are described herein, one of ordinary skill in the art will recognize that various other combinations of elements are possible and will fall within the general inventive concepts. Likewise, one of ordinary skill in the art will understand that the various embodiments of nonwoven mats described herein are suitable for use in the methods described herein.

### EXAMPLES

### Example 1

Nonwoven glass mats comprising novel blends of glass fibers were prepared in the following manner. Nonwoven mats were prepared by a conventional wet-laid coating process in which chopped glass fibers, after being deposited onto a moving screen in the form of an aqueous slurry, were coated with an aqueous dispersion of a binder composition (also referred to as a precursor binder) and then dried and cured. A conventional urea formaldehyde formulation was used in as binder. All mats were cured at 450° F. (232° C.).

Example A comprised mats formed using an 80/20 blend of chopped glass fibers, with 80% of the fibers having a length of 19 mm and a diameter of 13 μm and 20% of the fibers having a length of 6 mm and a diameter of 7.5 μm. Example B comprised mats formed using an 80/20 blend of chopped glass fibers, with 80% of the fibers having a length of 19 mm and a diameter of 11 μm and 20% of the fibers having a length of 6 mm and a diameter of 7.5 μm. Two comparative samples were also prepared: Comparative Example A included 100% 19 mm long and 13 μm diameter fibers and Comparative Example B included 100% 19 mm long and 11 μm diameter fibers. The blended fibers were formed into webs of randomly oriented fibers using a wet-laid process, as disclosed herein. A binder comprising an aqueous mixture containing about 90% by weight solids of a urea formaldehyde and about 10% by weight acrylic was applied to the webs by a curtain coater. The nonwoven mats had basis weights of 2.2 lbs./CSF (107.4 g/m²) and LOIs of 22%.

The nonwoven mats were then tested for air porosity or permeability using an air permeability tester FX 3300. The air pressure is controlled at 125 Pa and the permeability readings were provided in CFM (rate of flow of air in cubic feet per square foot of sample area per minute).

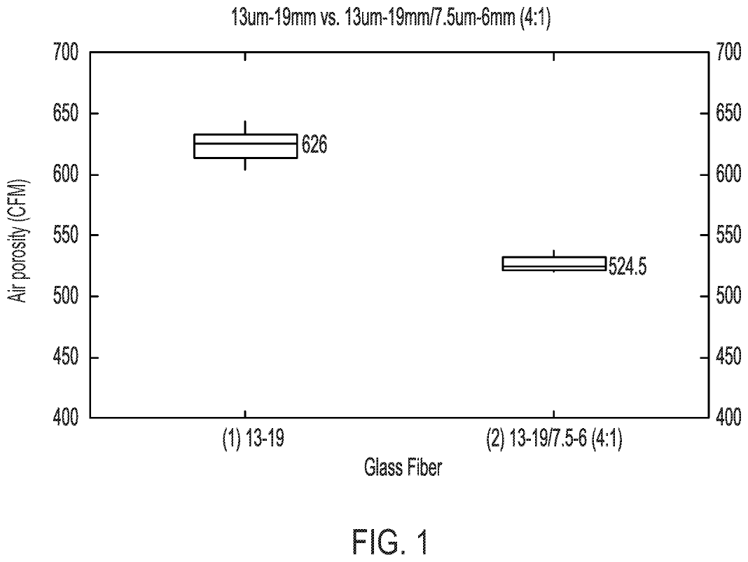

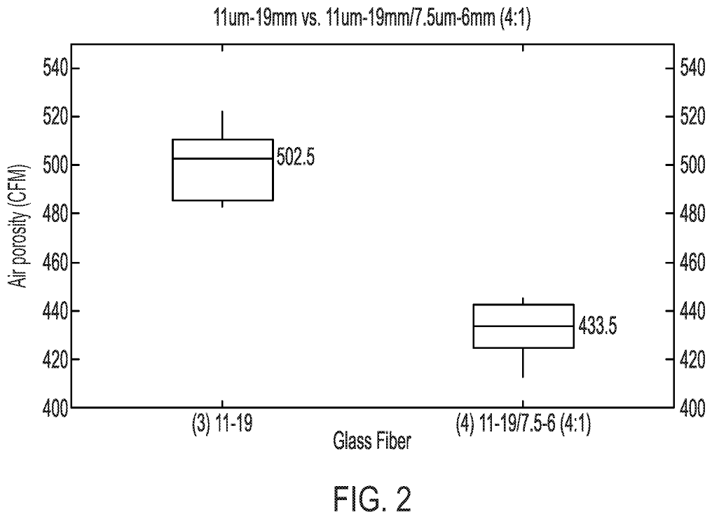

FIG. 1 reflects the air porosity of the nonwoven mats of Comparative Example A vs. Example A. The reduced air porosity is believed to result in reduced gypsum bleed through. Example A demonstrated an average air porosity of about 524.5 CFM, which is significantly lower than Comparative Example A, demonstrating an average air porosity of about 626 CFM. Similarly, FIG. 2 reflects the air porosity of the nonwoven mats of Comparative Example B vs. Example B. Example B demonstrated an average air porosity of about 433.5 CFM, which is lower than the average air porosity of about 502.5 CFM, observed in Comparative Example B.

The hydrophobicity of the mats was also determined by measuring the Cobb values. Each mat demonstrated a Cobb value greater than 1 g, which indicates that the mat is hydrophilic.

The mats were then tested for potential gypsum bleed through, using a weighted gypsum bleed-through test. In this test, metal sheet trays were prepared by lining the trays with plastic bags. The mats were arranged on the trays and a 4×4 piece of black construction paper was placed under each mat. Gypsum slurry was then poured onto each mat, creating a gypsum slump pile about 3-4 inches in diameter on each mat. The gypsum piles were covered with plastic and test weights were placed on the plastic-coated gypsum piles. The test weights were 0.45 kg or 4.3 kg weights with a 3-inch diameter circular area contacting the gypsum. The weights remained on the samples for 1 minute. After 1 minute, the weights were removed and the samples were left covered for 20 minutes (based on when the weights were added). After 20 minutes, the plastic was removed from the top of the samples and the paper was observed for gypsum bleed-through.

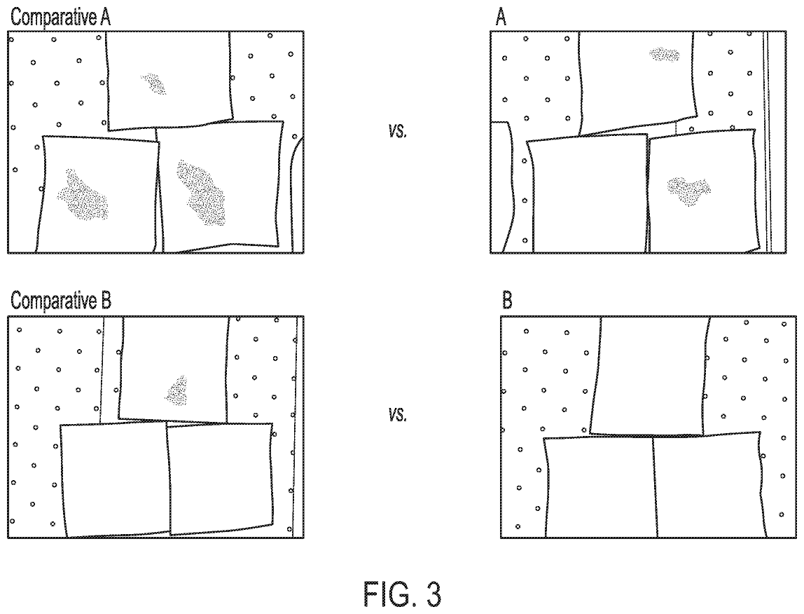

FIG. 3 illustrates the bleed-through test results using a 0.45 kg weight, wherein Comparative Example A demonstrated significantly more bleed-through compared to Example A where the bleed-through was significantly reduced. Similar results were seen comparing Comparative Example B with Example B, which demonstrated zero bleed-though. These examples also show that adding the selected small diameter fibers into the nonwoven mat reduces gypsum bleed-through.

### Example 2

Nonwoven glass mats comprising novel blends of glass fibers were prepared in the following manner. Non-woven mats were made by a conventional wet laid coating process in which chopped glass fibers, after being deposited onto a moving screen in the form of an aqueous slurry, were coated with an aqueous dispersion of a binder composition (also referred to as a precursor binder) and then dried and cured. A typical Urea formaldehyde formulation was used in as binder. All mats were cured at 450° F. (232° C.).

Glass Blend 1 included an 60/40 blend of chopped glass fibers, with 60% of 19 mm long and 11 μm diameter fibers and 40% of 6 mm long and 6.5 μm diameter fibers. Glass Blend 2 included 80/20 blend of chopped glass fibers, with 80% of 19 mm long and 11 μm diameter fibers and 20% of 6 mm long and 6.5 μm diameter fibers. Glass Blends 1 and 2 were then each combined with two different binder compositions to form nonwoven mats. Example 1A comprised Glass Blend 1 and a binder composition comprising acrylic and 0.2 wt. % solids of a fluorocarbon water-repellent additive. Example 1B comprised Glass Blend 1 and a binder composition comprising urea formaldehyde and acrylic (90/10 ratio), along with 0.6 wt. % solids of a fluorocarbon water-repellent additive. Example 2A comprised Glass Blend 2 and a binder composition comprising acrylic and 0.2 wt. % solids of a fluorocarbon water-repellent additive. Example 2B comprised Glass Blend 2 and a binder composition comprising urea formaldehyde and acrylic (90/10 ratio), along with 0.6 wt. % solids of a fluorocarbon water-repellent additive. The nonwoven mats had basis weights of 2.5 lb/CSF (122 g/m²) and LOIs of 25%.

The nonwoven mats were then tested for air porosity or permeability using an air permeability tester FX 3300. The air pressure is controlled at 125 Pa and the permeability readings were provided in CFM (rate of flow of air in cubic feet per square foot of sample area per minute).

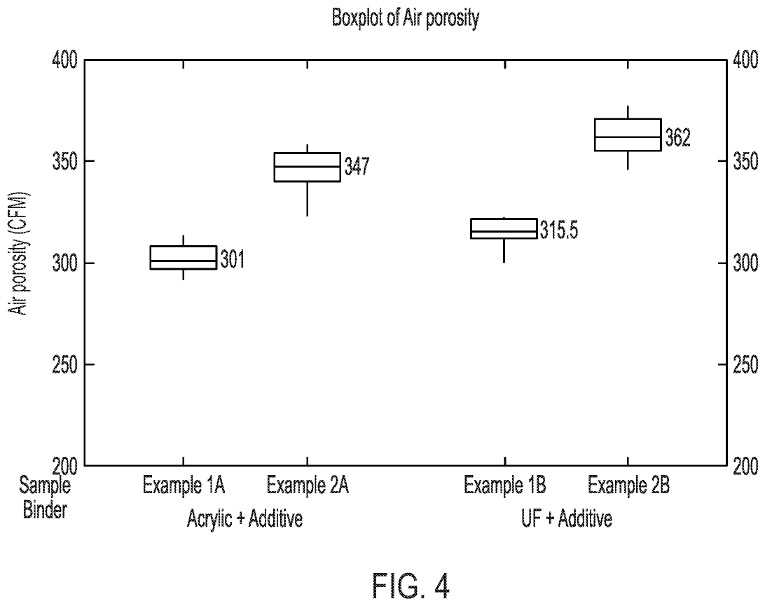

FIG. 4 reflects the air porosity of the nonwoven mats of Examples 1A, 1B, 2A, and 2B. As illustrated, each of the examples demonstrates an air porosity less than 400 CFM. Examples 1A and 1B, each including Glass Blend 1 (an 60/40 blend of chopped glass fibers, with 60% of 19 mm long and 11 μm diameter fibers and 40% of 6 mm long and 6.5 μm diameter fibers) demonstrated the lowest air porosities, with each having air porosities below 325 CFM (301 CFM and 315.5, respectively).

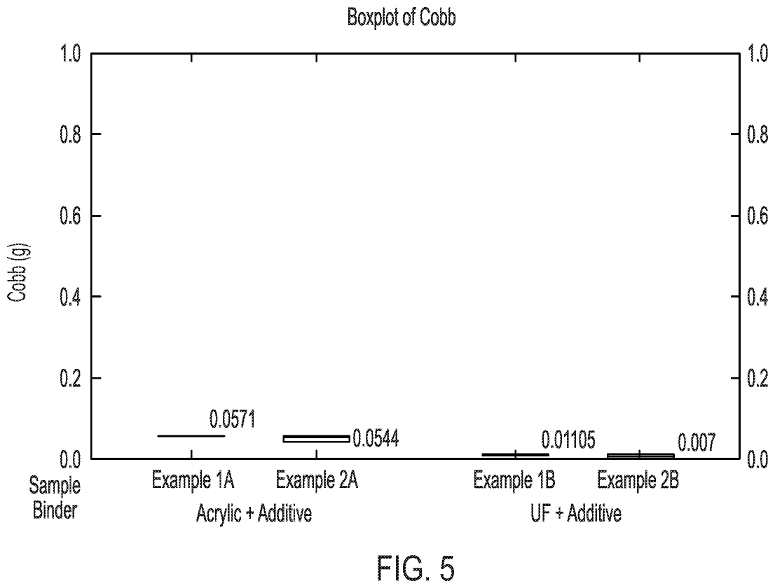

FIG. 5 reflects the Cobb values for each of Examples 1A, 1B, 2A, and 2B illustrated, each mat demonstrated a Cobb value less than 0.1 g, with Examples 1B and 2B (urea formaldehyde+acrylic binder) demonstrating the lowest Cobb values at less than 0.05 g (Cobb values of 0.01105 g and 0.007 g, respectively). As the Cobb values were much less than 1 g, this indicates that the mats have hydrophobic properties.

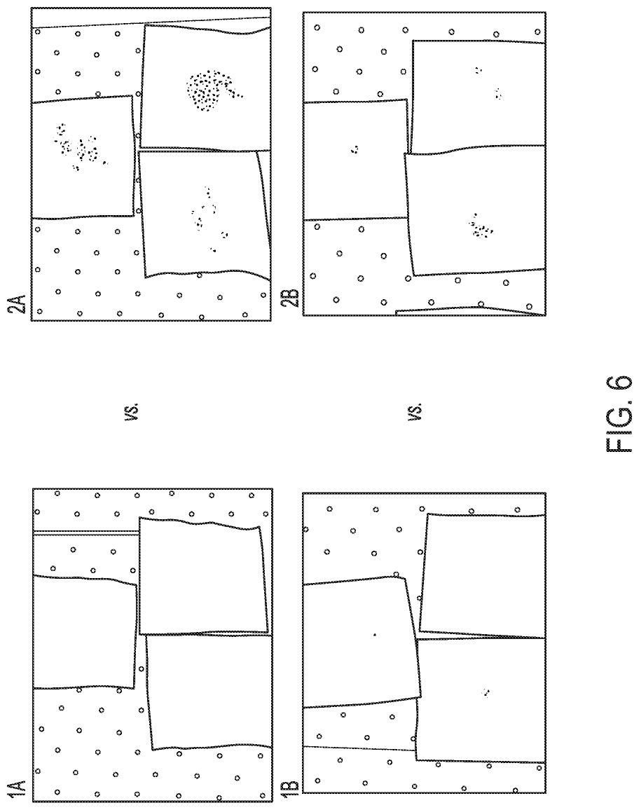

The mats were then tested for potential gypsum bleed through, using the weighted gypsum bleed-through test, as outlined in Example 1. FIG. 6 illustrates the bleed-through test results using a 4.3 kg weight, which is considered a more aggressive bleed-through test, wherein each of Examples 1A, 1B, 2A, and 2B demonstrated significantly reduced bleed-through compared to Example 1, above, by the inclusion of water-repellant additives. Additionally, higher concentration of the 6.5-micron fibers in the mats further reduced the gypsum bleed-through, as can be seen by comparing Examples 1A and 1B with 2A and 2B. In some exemplary embodiments, the nonwoven mats demonstrate less than 5% gypsum bleed-though when a pressure of 4.3 kgs is applied. In some exemplary embodiments, the nonwoven mats demonstrate less than 2.5% gypsum bleed-though when a pressure of 4.3 kgs is applied.

### Example 3

The nonwoven mats of Example 2 were then used as a facer and back mat on a gypsum board. The four mat samples (1A, 1B, 2A, and 2B) showed good performance against gypsum bleed-through, with only slight gypsum bleed-through seen in facer 2B. No bleed-through was seen for any of the other mat samples.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative process, and illustrative examples shown and described. Accordingly, departures may be made from such details without departing from the spirit or scope of the applicant's general disclosure herein.

1-26. (canceled)

27. An uncoated nonwoven fibrous mat comprising:
a first plurality of fibers having a length between about 10 mm and about 20 mm and an average diameter between about 9 μm and about 15 μm;
a second plurality of fibers having a length between about 3 mm and about 7 mm and an average diameter between about 6.5 μm and about 8 μm, the second plurality of fibers comprising 15 to 45 weight percent of a total weight of fibers in the uncoated nonwoven fibrous mat; and
a hydrophobic binder composition selected from the group consisting of acrylic binders, formaldehyde binders, and mixtures thereof, the binder composition including 0.1 to 5 weight percent of one or more water-repellent additives,
wherein the uncoated nonwoven fibrous mat has an air porosity between 300 CFM and 550 CFM.

28. The uncoated nonwoven fibrous mat of claim 27, wherein the first and second plurality of fibers comprise one or more of glass fibers, carbon fibers, mineral fibers, ceramic fibers, natural fibers, and synthetic fibers.

29. The uncoated nonwoven fibrous mat of claim 27, wherein at least one of the first and second plurality of fibers comprise glass fibers.

30. The uncoated nonwoven fibrous mat of claim 27, wherein the first plurality of fibers have an average diameter of about 10 μm to about 13 μm,
wherein the second plurality of fibers have an average diameter of about 6 μm to about 7.5 μm.

31. The uncoated nonwoven fibrous mat of claim 27, wherein the first plurality of fibers and second plurality of fibers are present in the uncoated nonwoven fibrous mat in a ratio from about 1:1 to about 15:1.

32. The uncoated nonwoven fibrous mat of claim 27, wherein the binder composition comprises 0 to about 25 weight percent acrylic and about 75 to about 100 weight percent urea formaldehyde.

33. The uncoated nonwoven fibrous mat of claim 27, wherein the water-repellent additives comprise silicone-based hydrophobing agents, wax additives, fluorocarbon compounds, or mixtures thereof.

34. The uncoated nonwoven fibrous mat of claim 27, wherein the uncoated nonwoven fibrous mat has a Cobb value less than 1.0 g.

35. The uncoated nonwoven fibrous mat of claim 27, wherein the uncoated nonwoven fibrous mat has a basis weight from about 1.5 lbs/CSF to about 3.5 lbs/CSF.

36. A gypsum board comprising:
a gypsum core having a first surface and an opposing second surface; and
at least one uncoated nonwoven fibrous mat having a first side and a second side, opposite the first side, wherein the first side of the uncoated nonwoven fibrous mat is adhered to the first surface of the gypsum core, the uncoated nonwoven fibrous mat comprising:
a first plurality of fibers having a length between about 10 mm and about 20 mm and an average diameter between about 9 μm and about 15 μm;
a second plurality of fibers having a length between about 3 mm and about 78 mm and an average diameter between about 6.5 μm and about 8 μm; and
a binder composition selected from the group consisting of acrylic binders, formaldehyde binders, and mixtures thereof, the binder composition including one or more water-repellent additives,
wherein the gypsum core penetrates less than 5% of the second side of the uncoated nonwoven fibrous mat, under a pressure of 4.3 kg, and
wherein the uncoated nonwoven fibrous mat has a Cobb value less than 0.5 g.

37. The gypsum board of claim 36, wherein the first and second plurality of fibers comprise one or more of glass fibers, carbon fibers, mineral fibers, ceramic fibers, natural fibers, and synthetic fibers.

38. The gypsum board of claim 36, wherein at least one of the first and second plurality of fibers comprise glass fibers.

39. The gypsum board of claim 36, wherein first plurality of fibers has an average diameter of about 10 μm to about 13 μm,
wherein the second plurality of fibers has an average diameter of about 6 μm to about 7.5 μm.

40. The gypsum board of claim 36, wherein the first and second plurality of fibers are present in the uncoated nonwoven fibrous mat in a ratio from about 1:1 to about 5:1.

41. The gypsum board of claim 36, wherein the binder composition comprises about 1 to about 25 weight percent acrylic and about 75 to about 100 weight percent urea formaldehyde.

42. The gypsum board of claim 36, wherein the water-repellent additives comprise fluorocarbons, fluorine-containing polymers or oligomers, fluorine-containing polysiloxane, or mixtures thereof.

43. The gypsum board of claim 36, wherein the gypsum core penetrates less than 2.5% of the second side of the uncoated nonwoven fibrous mat, under a pressure of 4.3 kg.

44. The gypsum board of claim 36, wherein the uncoated nonwoven fibrous mat has a Cobb value less than 1.0 g.

45. The gypsum board of claim 36, wherein the uncoated nonwoven fibrous mat has a basis weight from about 1.5 lbs/CSF to about 3.5 lbs/CSF.

46. A method of manufacturing an uncoated nonwoven fibrous mat with reduced air porosity, the method comprising:
mixing a first plurality of fibers having a length between about 10 mm and about 20 mm and an average diameter between about 9 μm and about 15 μm and a second plurality of fibers having a length between about 3 mm and about 8 mm and an average diameter between about 6.5 μm and about 8 μm in a white-water solution to disperse the fibers and form a blended glass fiber slurry;
depositing the blended glass fiber slurry on a conveying apparatus;
removing a portion of the water from the slurry to form a fiber web;
applying a binder composition to the fiber web to form a binder-coated fiber web; and
curing the binder-coated fiber web to form the uncoated nonwoven fibrous mat, wherein the uncoated nonwoven fibrous mat has an air porosity from about 300 CFM to about 550 CFM.
